(19) United States
(12) Patent Application Publication
(10) Pub. No.: US 2023/0394398 A1
(43) Pub. Date: Dec. 7, 2023

(54) HUMAN RESOURCE SCHEDULING METHOD AND ELECTRONIC APPARATUS FOR SCHEDULING HUMAN RESOURCES

(71) Applicant: Wistron Corporation, New Taipei City (TW)

(72) Inventors: Yu-Ching Lin, New Taipei City (TW); Guan-He Wu, New Taipei City (TW); Hsien-Hung Shih, New Taipei City (TW)

(73) Assignee: Wistron Corporation, New Taipei City (TW)

(21) Appl. No.: 17/965,765

(22) Filed: Oct. 14, 2022

(30) Foreign Application Priority Data
Jun. 7, 2022 (TW) 111121096

(51) Int. Cl. G06Q 10/06; G06Q 10/04

(52) U.S. Cl. CPC G06Q 10/06312; G06Q 10/067; G06Q 10/04

(57) ABSTRACT

A human resource scheduling method and an electronic apparatus for scheduling human resources are provided. A test model is constructed based on a test objective function and a plurality of test constraint formulas. The test model is applied to substitute set data into the test constraint formulas, so that the test constraint formulas are applied to find a solution based on the test objective function to determine whether the set data are valid based on the solution. In response to the test model determining that the set data are valid, the set data is input into an optimization model to obtain a human resource scheduling plan.

### CROSS-REFERENCE TO RELATED APPLICATION

This application claims the priority benefit of Taiwan patent application no. 111121096, filed on Jun. 7, 2022. The entirety of the above-mentioned patent application is hereby incorporated by reference herein and made a part of this specification.

### BACKGROUND

### Technical Field

The disclosure relates to a work shift planning mechanism; more particularly, the disclosure relates to a human resource scheduling method and an electronic apparatus for scheduling human resources.

### Description of Related Art

In the highly competitive industry, bottlenecks faced by enterprises are not to find a set of “feasible” solutions but to find a set of planned solutions that can guarantee “the lowest operating costs”. However, a number of factors are required to be considered in terms of an employee shift scheduling and maintenance and repair plan, and resource allocation is an extremely complex issue, which may lead to tens of millions of feasible plan combinations. Therefore, finding a set of feasible planned solutions that can guarantee “the lowest operating costs” within a reasonable period of time is a difficult challenge which needs to be overcome by enterprises.

### SUMMARY

The disclosure provides a human resource scheduling method and an electronic apparatus for scheduling human resources, by which a human resource scheduling plan at the lowest operating costs may be found in a very short period of time.

An embodiment of the disclosure provides a human resource scheduling method executed by a processor. The method includes following steps. A test model is constructed based on a test objective function and a plurality of test constraint formulas. Set data are substituted into the test model, so that the test constraint formulas find a solution based on the test objective function to determine whether the set data are valid based on the solution. In response to the test model determining that the set data are valid, the set data are input into an optimization model to obtain a human resource scheduling plan.

In an embodiment of the disclosure, the test objective function aims at minimizing a first tolerance factor of an upper limit of overtime hours and a second tolerance factor of an upper limit of consecutive working days; after determining whether the set data are valid based on the solution, in response to the test model determining that the set data are invalid, output data corresponding to the solution are fed back through the test objective function.

In an embodiment of the disclosure, the output data include the first tolerance factor or the second tolerance factor, and the step of determining whether the set data are valid by applying the test objective function includes the following. Whether the first tolerance factor or the second tolerance factor is equal to 0 is determined. In response to the first tolerance factor and the second tolerance factor being equal to 0, the set data are determined to be valid; in response to the first tolerance factor or the second tolerance factor being not equal to 0, the set data are determined to be invalid.

In an embodiment of the disclosure, the human resource scheduling plan includes an employee work shift plan, an employee task assignment plan, and a remaining work-in-process (WIP) number table. The employee work shift plan records work shift information of a plurality of employees, and the work shift information of each of the employees includes an attendance status, regular work shift hours, an overtime status, and overtime hours. The attendance status represents whether the employees are arranged to be present at a workplace, and the overtime status represents whether the employees are arranged to work overtime. The employee task assignment plan determines equipment model processing information of the employees, and the equipment model processing information of each of the employees includes: at least one equipment model, processing time of each of the at least one equipment model, units per person per hour (UPPH), and a processed number of each of the at least one equipment model, wherein the UPPH is a labor capacity per unit time. The remaining WIP number table determines a remaining WIP number of each of the at least one equipment model after the work shifts end.

In an embodiment of the disclosure, after obtaining the human resource scheduling plan, the human resource scheduling method further includes following steps. The employee work shift plan, the employee task assignment plan, and the remaining WIP number table are integrated to obtain an employee task plan, an employee work pivot table, and an employee work shift hours table. The employee task plan records all of the at least one equipment model corresponding to a type of order and processed by each of the employees, the processing time of each of the at least one equipment model, the UPPH, and the processed number of each of the at least one equipment model. The employee work pivot table records all of the at least one equipment model correspondingly processed by each of the employees, total processing time, and a total processed number of the at least one equipment model. The employee work shift hours table records the regular work shift hours and the overtime hours of each of the employees in attendance.

In an embodiment of the disclosure, the set data include an objective WIP number corresponding to a type of order, an upper limit of regular work shift hours, a bottom limit of regular work shift hours, an upper limit of overtime hours, a bottom limit of overtime hours, and an upper limit of consecutive working days. The test constraint formulas are applied to determine reasonableness of the set data based on the set data, employee attendance data, equipment model data, and employee work data. Here, the employee attendance data include the consecutive working days respectively corresponding to the employees. The equipment model data include a plurality of equipment models corresponding to a plurality of types of order, a current WIP number corresponding to each of the equipment models, and an expected WIP number corresponding to each of the equipment models. The employee work data include the equipment models which each of the employees is capable of handling and UPPH for each of the equipment models.

In an embodiment of the disclosure, the optimization model includes a plurality of optimized objective functions and a plurality of objective constraint formulas, and the objective constraint formulas are applied to determine the human resource scheduling plan. After the set data are input into the optimization model, the human resource scheduling method further includes: executing one by one the optimized objective functions based on a function precedence order.

In an embodiment of the disclosure, the optimized objective functions include a function of minimizing total overtime hours, a function of maximizing a total processed number of the at least one equipment model, and a function of minimizing a total number of the employees in attendance.

An embodiment of the disclosure provides an electronic apparatus including a storage device configured to store a test model and an optimization model and a processor coupled to the storage device. Here, the processor is configured to: construct the test model based on a test objective function and a plurality of test constraint formulas; substitute set data into the test model, so that the test constraint formulas find a solution based on the test objective function to determine whether the set data are valid based on the solution; in response to the test model determining that the set data are valid, input the set data into the optimization model to obtain a human resource scheduling plan.

An embodiment of the disclosure provides a human resource scheduling method executed by a processor. The method includes following steps. An optimization model is constructed based on a plurality of optimized objective functions and a plurality of objective constraint formulas, wherein the optimized objective functions include a function of minimizing total overtime hours, a function of maximizing a total processed number of equipment models, and a function of minimizing a total number of employees in attendance. Set data are input into the optimization model, and the optimized objective functions are executed one by one based on a function precedence order to obtain a human resource scheduling plan corresponding to the optimized objective functions.

In view of the above, the test model and the optimization model are constructed according to one or more embodiments of the disclosure, so as to determine whether the set data are valid by applying the test model. Besides, when the set data are determined to be invalid, the output data corresponding to the solution are fed back for users to evaluate and adjust relevant parameters. In the optimization model, the optimal solution to the employee shift scheduling and maintenance and repair plan is found based on the set optimized objective functions. As such, the combination of the functional constraint formulas in a mathematical model and the set optimized objection functions ensures that the human resource scheduling plan may be obtained at the lowest operating cost in a very short period of time.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block view of an electronic apparatus according to an embodiment of the disclosure.

FIG. 2 is a flowchart of a human resource scheduling method according to an embodiment of the disclosure.

FIG. 3 is a flowchart of a human resource scheduling method according to an embodiment of the disclosure.

### DETAILED DESCRIPTION OF THE EMBODIMENTS

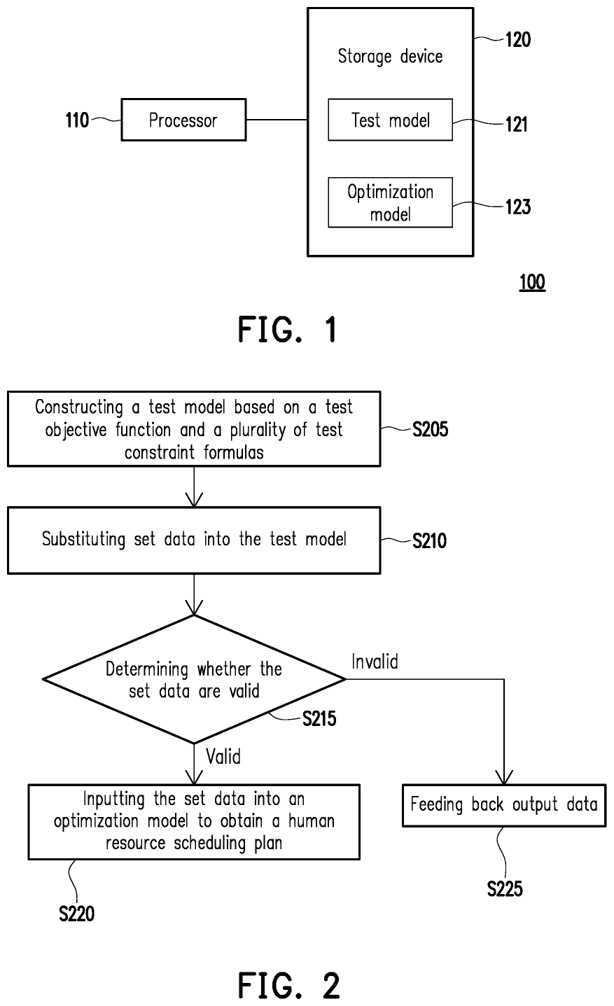

FIG. 1 is a block view of an electronic apparatus according to an embodiment of the disclosure. With reference to FIG. 1, an electronic apparatus 100 is, for instance, any electronic apparatus capable of performing computation functions, such as a smart phone, a tablet computer, a notebook computer, a personal computer, and a server, and so on. The electronic apparatus 100 at least includes a processor 110 and a storage device 120.

The processor 110 is, for instance, a central processing unit (CPU), a physics processing unit (PPU), a programmable microprocessor, an embedded control chip, a digital signal processor (DSP), an application specific integrated circuit (ASIC), or any other similar device.

The storage device 120 is, for instance, any type of fixed or movable random access memory (RAM), read only memory (ROM), flash memory, hard disk drive, any other similar device, or a combination of these devices. The storage device 120 is configured to store a test model 121 and an optimization model 123. The test model 121 and the optimization model 123 are composed of one or a plurality of programming code snippets. After the programming code snippets are installed, the processor 110 executes a human resource scheduling method described below.

Based on integer programming (IP), the test model 121 and the optimization model 123 are constructed in this embodiment. The test model 121 is designed based on the optimization model 123. First, the test model 121 is applied to determine whether set data are valid, and data corresponding to a solution are fed back for a user to evaluate and adjust relevant parameters. In the optimization model 123, a solution to employee work shift scheduling and task assignment planning (e.g., task assignment planning for repair, manufacture, assembly, welding, test, and so on) is to be found based on the optimized objective functions set by the user. In different decision-making scenarios, the user may also set a preferred precedence order of the optimized objective functions to optimize the solution through multiple levels of decision making.

In the disclosure, a CPLEX built-in heuristic algorithm search engine is applied to call various algorithms in the function library in a self-adaptive manner, such as a branch-and-cut algorithm, a primal/dual simplex algorithm, a network simplex algorithm, and so forth, so as to assist the user in quickly finding initial solutions and feasible solutions, escaping from local optimal solutions through self-adaptive relaxation of the objective functions, and finding global optimal solutions.

This disclosure introduces the self-adaptive relaxation method of constraint formulas. When such a method is carried out to find a solution by adopting the text model 121, appropriate tolerance factors (with values ≥0) may be applied to accelerate the convergence according to the matching degree between the current solution and the test constraint formulas, so as to quickly determine whether there exists any feasible solution and feed corresponding data back to the user for adjusting relevant parameters.

FIG. 2 is a flowchart of a human resource scheduling method according to an embodiment of the disclosure. With reference to FIG. 2, in step S205, the test model 121 is constructed based on a test objective function and a plurality of test constraint formulas.

In step S210, the set data are substituted into the test model 121, so that test constraint formulas find a solution based on the test objective function. The set data include an objective work-in-process (WIP) corresponding to a type of order, an upper limit of regular work shift hours, a bottom limit of regular work shift hours, an upper limit of overtime hours, a bottom limit of overtime hours, and an upper limit of consecutive working days.

In step S215, it is determined whether the set data are valid. That is, after finding the solution through the test constraint formulas based on the test objective function, whether the set data are valid is determined based on the solution. The test model 121 is mainly configured to determine whether there is a feasible solution under the given set data.

In response to the test model 121 determining that the set data are invalid (no feasible solution), in step S225, output data are fed back through the test objective function. Accordingly, through feeding back the output data (the solution), the user may evaluate and adjust relevant parameters and determine whether the set data are invalid again until the set data are determined as being valid.

In an embodiment, the storage device 120 further includes a user interface for the user to input data. That is, the processor 110 receives the user's input (e.g., the set data) through the user interface and may further display the fed-back output data through the user interface.

In response to the test model 121 determining that the set data are valid (with a feasible solution), in step S220, the set data are input into the optimization model 123 to obtain a human resource scheduling plan.

The optimization model 123 and the test model 121 applied in a maintenance and repair task assignment are further explained below. However, in other embodiments, a solution to other task assignment plans, such as manufacturing, assembling, soldering, testing, and so on, may also be found.

The optimization model 123 includes a plurality of optimized objective functions and a plurality of objective constraint formulas. In this embodiment, the final objective of the optimization model 123 is to minimize the total overtime hours, maximize the total processed number of equipment models, and minimize the total number of employees in attendance. Optimized objective functions F1-F3 are explained below.

Optimized objective function F1: Min Σᵢ₌₁ⁿEOHᵢ, wherein EOHᵢ represents the overtime hours of employee i, and n is the total number of employees. The optimized objective function F1 serves to minimize the total overtime hours of all employees, so as to assist the users under various practical manufacturing restrictions in efficiently obtaining the employee shift scheduling and maintenance and repair plan at the lowest operating cost.

Optimized objective function F2: Max Σᵢ₌₁ⁿΣ_{j∈MRS}_{ᵢ}RPQᵢⱼ, wherein MRSi represents a set of the equipment models processable (maintainable and repairable) by the employee i, j represents the equipment model, and RPQᵢⱼ represents the processed (maintained and repaired) number of equipment model j by the employee i. The optimized objective function F2 serves to maximize the total processed number of the equipment models, so as to assist the users under various practical manufacturing restrictions in efficiently obtaining the employee shift scheduling and maintenance and repair plan with the highest operating efficiency.

Optimized objective function F3: Min Σᵢ₌₁ⁿxᵢ, wherein xᵢ=0 represents the employee i is not arranged to be present at the workplace, and xᵢ=1 represents the employee i is arranged to be present at the workplace. The optimized objective function F3 serves to minimize the total number of employees in attendance, so as to assist the users under various practical manufacturing restrictions in obtaining the employee shift scheduling and maintenance and repair plan which is considered as the optimal human resource scheduling plan.

The optimized objective functions designed by the optimization model 123 take two key performance indicators of operation management into account, namely costs and efficiency. In different decision-making scenarios, the optimized objective functions may be selected for making plans and finding the optimized solution according to the actual requirements. In addition, the optimized solution may also be found through multiple levels of decision making according to a function precedence order (which may be preset based on actual requirements).

The objective constraint formulas applied in the optimization model 123 are shown below.

Objective constraint formula P1: WHL×xᵢ≤EWHᵢ≤WHU×xᵢ, wherein EWHᵢ represents regular work shift hours of employee i (i=1, 2, . . . , n), xᵢ=0 represents the employee i is not arranged to be present at the workplace, and xᵢ=1 represents the employee i is arranged to be present at the workplace, WHL represents the bottom limit of regular work shift hours, and WHU represents the upper limit of regular work shift hours.

If the employee i is arranged to be present at the workplace (xᵢ=1), the objective constraint formula P1 serves to limit the planned regular work shift hours EWHᵢ to range between the bottom limit of regular work shift hours WHL and the upper limit of regular work shift hours WHU. On the contrary, if the employee i is not arranged to be present at the workplace (x=0), the planned regular work shift hours EWHᵢ is 0. Practically, the bottom limit of regular work shift hours WHL and the upper limit of regular work shift hours WHU may be dynamically adjusted in a strategic manner, and applying the objective constraint formula P1 may ensure that the work hours of the employees in attendance satisfy the rules in the workplace and allow more flexibility of the human resource scheduling plan.

Objective constraint formula P2: OTL×yᵢ≤EOHᵢ≤OTU×yᵢ, wherein EOHᵢ represents the overtime hours of the employee i, yᵢ=0 represents the employee i is not arranged to be present at the workplace yᵢ=1 represents the employee i is arranged to be present at the workplace, OTL represents the bottom limit of overtime hours, and OTU represents the upper limit of overtime hours.

If the employee i is arranged to work overtime (yᵢ=1), the objective constraint formula P2 serves to limit the planned overtime hours EOHᵢ to range between the bottom limit of overtime hours OTL and the upper limit of overtime hours OTU. On the contrary, if the employee i is not arranged to work overtime (yᵢ=0), the planned overtime hours EOHᵢ is 0. Practically, the bottom limit of overtime hours OTL and the upper limit of overtime hours OTU may be dynamically adjusted in a strategic manner, and applying the objective constraint formula P2 may ensure that the overtime hours of the employees satisfy the rules in the workplace and improve the cost efficiency of the arrangement of the overtime hours.

Objective constraint formula P3: WHU-EWHᵢ≤(1−yᵢ)·WHU. The objective constraint formula P3 serves to arrange the employee i to work overtime (yᵢ=1) when the regular work shift hours EWHᵢ of the employee i is equal to the upper limit of regular work shift hours WHU; otherwise, the employee i cannot be arranged to work overtime (yᵢ=0). Applying the objective constraint formula P3 may ensure the reasonableness of the employee overtime plan and avoid wasting labor costs.

Objective constraint formula P4: CWDᵢ·xᵢ≤SWD−1, wherein CWDᵢ represents the current consecutive working days of the employee i, and SWD represents the upper limit of consecutive working days. If the employee i is arranged to be present at the workplace (xᵢ=1), the objective constraint formula P4 serves to limit the current consecutive working days CWDᵢ of the employee i to be less than the upper limit of consecutive working days SWD. On the contrary, if the current consecutive working days CWDᵢ of the employee i are already greater than or equal to the upper limit of consecutive working days SWD, the employee i is not arranged to be present at the workplace (xᵢ=0). Practically, based on labor policies, the attendance arrangement of employees should take the accumulated consecutive working days of the employees into consideration. Applying the objective constraint formula P4 may ensure the reasonableness of the employee attendance plan and guarantee the compliance with the relevant policies.

Objective constraint formula P5:

$$E W {H}_{i} + E O {H}_{i} - SLT \leq {\sum }_{j ∈ M R {S}_{i}} \frac{R P {Q}_{i j}}{U P P {H}_{i j}} \leq EW {H}_{i} + E O {H}_{i} ,$$

wherein MRSi represents a set of the equipment models maintainable and repairable by the employee i, j represents the equipment model, and RPQᵢⱼ represents the processed (maintained and repaired) number of equipment model j by the employee i.

$${\sum }_{j ∈ M R {S}_{i}} \frac{R P {Q}_{i j}}{U P P {H}_{i j}}$$

represents the sum of work hours spent on each equipment model j among the set MRSᵢ of the equipment models maintainable and repairable by the employee i (the actual maintenance and repair work hours). SLT represents allowance time of the employee i, and 0<SLT≤1. UPPHᵢⱼ represents units per person per hour (UPPH) of the employee i maintaining and repairing the equipment model j. The UPPH is a labor capacity per unit time, which is the ratio of workload (the number of tasks) to the number of hours worked times the number of workers. UPPH=workload/(the number of hours worked×the number of workers). The sum of the regular work shift hours EWHᵢ and the overtime hours EOHᵢ indicates the planned total work hours.

The objective constraint formula P5 serves to limit the upper limit of and bottom limit of actual maintenance and repair work hours of the employee i. Practically, reduction of operating efficiency and time loss may result from fatigue of the employees or other factors, and the objective constraint formula P5 takes the allowance time SLT into consideration, so as to ensure the reasonableness of the arrangement of the work hours of the employees in attendance and the maintenance and repair plan and the reasonableness of the output evaluation.

Objective constraint formula P6: Σ_{j∈MRS}_{ᵢ}RPQᵢⱼ≥xᵢ ∘ If the employee i is arranged to be present at the workplace (xᵢ=1), the objective constraint formula P6 serves to limit the sum Σ_{j∈MRS}_{ᵢ}RPQᵢⱼ of the planned work hours spent on each equipment model j among the set MRSᵢ of the equipment models maintainable and repairable by the employee I is greater than 0. On the contrary, if the employee i is not arranged to be present at the workplace (xᵢ=0), Σ_{j∈MRS}_{ᵢ}RPQᵢⱼ is equal to 0. Applying the objective constraint formula P6 may ensure the reasonableness of the arrangement of employee attendance and the maintenance and repair scheduling plan and guarantee the compliance with the practical scheduling logic.

Objective constraint formula P7: Σ_{j∈ERS}_{ⱼ}=CWQⱼ+IWQⱼ, and j∈MDS₁. Here, ERSⱼ represents a set of employees capable of processing (maintaining and repairing) the equipment model j, CWQⱼ represents the current WIP number of the equipment model j, IWQⱼ represents the expected WIP number of the equipment model j, and MDSₖ represents a set of equipment models corresponding to a type of order k, wherein k=1 represents that the type of order is “configuration to order” (CTO), k=2 represents that the type of order is “build to order” (BTO), and MDS₁ represents a set of equipment models corresponding to the type of order CTO.

The objective constraint formula P7 serves to limit the equipment model j corresponding to the type of order CTO, i.e., the processed number of equipment models j corresponding to the type of order CTO and processed (maintained and repaired) by the employee i. Practically, the type of order CTO is required to be maintained and repaired with high priority, and applying the objective constraint formula P7 ensures accomplishment of such goal.

Objective constraint formula P8: Σ_{j∈ERS}_{ⱼ}RPQᵢⱼ≤CWQⱼ+IWQⱼ, j∈MDS₂. The objective constraint formula P8 serves to limit the equipment model j corresponding to the type of order BTO, i.e., the processed number of the equipment models j corresponding to the type of order BTO and processed (maintained and repaired) by the employee i. Practically, the maintenance and repair plan should be scheduled to check the upper limit of number of each equipment model which corresponds to the type of order BTO and can be processed, and applying the objective constraint formula P8 ensures the reasonableness of the arrangement of the maintenance and repair plan.

Objective constraint formula P9: Σ_{j∈MDS}_{₂}(CWQⱼ+IWQⱼ−Σ_{j∈ERS}_{ⱼ}RPQᵢⱼ)≤TWQ, wherein TWQ represents an objective WIP number corresponding to the type of order BTO. The objective constraint formula P9 serves to limit the sum (CWQⱼ+IWQⱼ−Σ_{i∈ERS}_{ⱼ}RPQᵢⱼ) of the remaining processed number of the equipment model j corresponding to the type of order BTO to be less than or equal to the objective WIP number TWQ corresponding to the type of order BTO. Practically, when the maintenance and repair plan is being formulated, the WIP number control should also be taken into account to shorten the production cycle and reduce the risk of overstocking, and applying the objective constraint formula P9 may ensure the maintenance and repair plan to meet this performance indicator, thus effectively responding to customers' needs and improving service quality.

The test model 121 is designed based on the optimization model 123 and serves to determine whether there exists any feasible solution while the set data are provided and feed output data back to users for evaluation, so as to adjust relevant parameters. In this embodiment, the test objective function aims at minimizing a first tolerance factor of the upper limit of overtime hours OTU and a second tolerance factor of the upper limit of consecutive working days SWD and are set as follows.

Test objective function TF: Min z+M·Σᵢ₌₁ⁿuᵢ, wherein uᵢ represents the first tolerance factor of the upper limit of overtime hours OTU of the employee i, z represents the second tolerance factor of the upper limit of consecutive working days SWD, and n represents the total number of employees.

In the test objective function TF, the sum Σᵢ₌₁ⁿuᵢ of the first tolerance factor uᵢ has an upper limit of positive value M (penalty coefficient), which drives the test model 121 to consider the second tolerance factor z of the upper limit of consecutive working days SWD with priority while the test model 121 is applied to find a solution, and the optimal value of the first tolerance factor uᵢ is kept to be 0 as best as it can be. If uᵢ*=max_{i≤i≤n}{uᵢ} and z* respectively represent the optimal value, it can be learned that the upper limit of overtime hours OUT and the upper limit of consecutive working days SWD should be respectively adjusted to OTU+uᵢ* and SWD+z*.

The test model 121 serves to ensure the reasonableness of the human resource planning based on set data, employee attendance data, equipment model data, and employee work data. The employee attendance data include the consecutive working days respectively corresponding to the employees. The equipment model data include a plurality of equipment models corresponding to a plurality of types of order, a current WIP number corresponding to each of the equipment models, and an expected WIP number corresponding to each of the equipment models. The employee work data include all equipment models processable (maintainable and repairable) by each of the employees and UPPH for each of the equipment models. In this embodiment, the test model 121 includes following test constraint formulas T1-T10.

Test constraint formula T1: WHL×xᵢ≤EWHᵢ≤WHU×xᵢ, which is the same as the objective constraint formula P1 and serves to ensure that the work hours of the employees in attendance satisfy the rules in the workplace.

Test constraint formula T2: OTL×yᵢ≤EOHᵢ≤OTU×yᵢ+u_{i′}, which is based on the objective constraint formula P2, and the first tolerance factor uᵢ of the upper limit of overtime hours OTU is further added.

Test constraint formula T3: uᵢ≤M×yᵢ, wherein M is an upper limit of positive value. If the employee i is arranged to work overtime (yᵢ=1), the test constraint formulas T2 and T3 serve to limit the planned overtime hours EOHᵢ to range between OTL and OTU+uᵢ. On the contrary, if the employee i is not arranged to work overtime (yᵢ=0), the corresponding first tolerance factor uᵢ=0, and the planned overtime hours EOHᵢ is 0.

Test constraint formula T4: WHU−EWHᵢ≤(1−yᵢ)·WHU, which is the same as the objective constraint formula P3 and serves to ensure the reasonableness of the employee overtime plan and avoid wasting labor costs.

Test constraint formula T5: CWDᵢ·xᵢ≤(SWD+z)−1, which is based on the objective constraint formula P4, and the second tolerance factor z of the upper limit of consecutive working days SWD is further added. If the employee i is arranged to be present at the workplace (xᵢ=1), the test constraint formula T5 serves to limit the current consecutive working days CWDᵢ of the employee i to be less than SWD+z. Here, the upper limit of value of the second tolerance factor z may be further inferred as max_{1≤i≤n}{CWDᵢ}+1−SWD. If max_{1≤i≤n}{CWDᵢ}+1>SWD, it indicates that raising the upper limit of value of the second tolerance factor z may be taken into consideration, so as to make possible arrangements by increasing the number of employees in attendance. On the contrary, if max_{1≤i≤n}{CWDᵢ}+1≤SWD, it indicates that all of the employees are in attendance, and hence reducing the upper limit of value may be taken into account to further improve the performance of the planning system.

Test constraint formula T6:

$$EW {H}_{i} + E O {H}_{i} - SLT \leq {\sum }_{j ∈ M R {S}_{i}} \frac{R P {Q}_{i j}}{U P P {H}_{i j}} \leq EW {H}_{i} + E O {H}_{i} ,$$

which is the same as the objective constraint formula P5.

Test constraint formula T7: Σ_{j∈MRS}_{ᵢ}RPQᵢⱼ≥xᵢ, which is the same as the objective constraint formula P6.

Test constraint formula T8: Σ_{j∈ERS}_{ⱼ}RPQᵢⱼ=CWQⱼ+IWQ_{j′}j∈MDS₁, which is the same as the objective constraint formula P7.

Test constraint formula T9: Σ_{j∈ERS}_{ⱼ}RPQᵢⱼ≤CWQⱼ+IWQ_{j′}j∈MDS₂, which is the same as the objective constraint formula P8.

Test constraint formula T10: Σ_{j∈MDS}_{₂}(CWQⱼ+IWQⱼ−Σ_{j∈ERS}_{ⱼ}RPQᵢⱼ)≤TWQ, which is the same as the objective constraint formula P9.

In practice, the maintenance and repair plan is mainly subject to two human resource constraints, i.e., the consecutive working days and the upper limit of overtime hours of employees. The consecutive working days pose an impact on the total number of employees that can be scheduled for the shifts on that day, and the upper limit of overtime hours determine the upper limit of work hours that can be arranged for each employee in attendance. Therefore, the test model 121 introduces a tolerance factor respectively for these two parameters and minimizes the tolerance factors as decision variables. As to the concept of said design, after the solution is found by the test model 121, if the tolerance factor value is 0, it means that the currently set an upper limit of consecutive working days and an upper limit of overtime hours have feasible solutions, and the optimization model 123 may be applied to further find a solution. On the contrary, the optimal values of the tolerance factors may be fed back to the user, and the fed-back output data may be displayed, wherein the fed-back output data may be applied to suggest how to adjust the parameters of the consecutive working days and the upper limit of overtime hours of the employees. After the evaluation result is confirmed, the optimization model 123 is applied to find a solution with the adjusted parameter values. The output data include a first tolerance factor uᵢ or a second tolerance factor z. The step of determining whether the set data are valid through the test objective function includes: determining whether the first tolerance factor uᵢ or the second tolerance factor z is equal to 0; in response to the first tolerance factor uᵢ and the second tolerance factor z being equal to 0, determining that the set data are valid; in response to the first tolerance factor uᵢ or the second tolerance factor z being not equal to 0, determining that the set data are invalid.

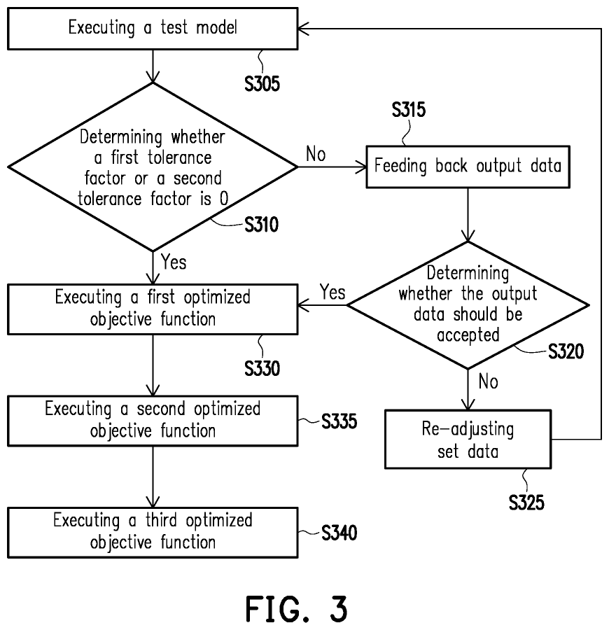

FIG. 3 is a flowchart of a human resource scheduling method according to an embodiment of the disclosure. With reference to FIG. 3, in step S305, the processor 110 is configured to execute the text model 121. In step S310, the processor 110 is configured to determine whether the first tolerance factor uᵢ or the second tolerance factor z is equal to 0.

If the first tolerance factor uᵢ or the second tolerance factor z is not equal to 0, it is determined that set data are invalid, and a step S315 is performed to feed back the output data from the test model 121. Next, in step S320, the user evaluates whether to accept the output data. For instance, the output data are a suggested value OTU+ui* of the upper limit of consecutive working days of the employee and a suggested value SWD+z* of the upper limit of overtime hours of the employee.

If the output data are accepted, after the set data are adjusted to the suggested values, step S330 and step S340 are performed. If the output data are not accepted, the set data are re-adjusted in step S325. After that, step S305 is performed again. For instance, the objective WIP number is increased, and the regular work shift hours are adjusted. Alternatively, the demand of the type of order CTO may be further adjusted, the number of employees may be increased, and so on.

If the first tolerance factor uᵢ and the second tolerance factor z are equal to 0, it is determined that the set data are valid, and step S330 and step S340 are performed. The first optimized objective function to the third optimized objective function in step S330 to step S340 are, for instance, the optimized objective functions F1 to F3, respectively, which should however not be construed as a limitation in the disclosure. In other embodiments, the output data applied in step S310 may also be the second tolerance factor z.

For instance, in step S330, the optimized objective function F1 is applied to obtain the human resource scheduling plan while the total overtime hours of all employees are minimized. Next, in step S335, the optimized objective function F2 is applied to obtain the human resource scheduling plan while the total processed number of the equipment models is maximized. After that, in step S340, the optimized objective function F3 is applied to obtain the human resource scheduling plan while the total number of employees in attendance is minimized.

In the electronic apparatus 100, an optimized objective function option may be further set in the user's interface for the user to determine a precedence order of the optimized objective functions F1, F2, and F3. For instance, it is assumed that the optimized objective functions F1 to F3 are respectively set as the optimized objective functions of the first, second, and third stages according to the precedence order determined by the user. Here, the processor 110 executes step S330 to obtain the human resource scheduling plan while the total overtime hours of all employees are minimized. Next, in step S335, the processor 110 applies the function value of the optimized objective function F1 as a constant parameter and substitutes it into the optimized objective function F2 of the second stage as a constraint formula, so as to obtain the human resource scheduling plan while the total processed number of the equipment models is maximized. After that, in step S340, the processor 110 applies the function value of the optimized objective function F2 as another constant parameter and substitutes it into the optimized objective function F3 of the third stage as another constraint formula, so as to obtain the human resource scheduling plan while the total number of employees in attendance is minimized. Accordingly, the multi-level objective planning function of the optimization model is realized. In other embodiments, one or two of the optimized objective functions F1, F2, and F3 may be executed, and the design scheme thereof may be determined according to the actual needs.

The human resource scheduling plan includes an employee work shift plan, an employee task assignment plan, and a remaining work-in-process number table. The employee work shift plan records work shift information of a plurality of employees. The work shift information of each of the employees includes an attendance status (whether the corresponding employee is arranged to be present at a workplace), regular work shift hours, an overtime status (whether the corresponding employee is arranged to work overtime), and overtime hours.

The employee task assignment plan determines equipment model processing information of the employees. The equipment model processing information of each of the employees includes equipment models, processing time of each of equipment models, UPPH, and a processed number of each of the equipment models. The remaining WIP number table determines a remaining WIP number of each of the equipment models after the work shifts end.

Another example is provided hereinafter for further explanation.

Parameters required by the test model 121 and the optimization model 123 include the employee attendance data (referring to Table 1), the equipment model data (referring to Table 2), the employee work data (referring to Table 3), and the set data. The employee attendance data include the consecutive working days respectively corresponding to the employees. The equipment model data include a plurality of equipment models corresponding to a plurality of types of order, a current WIP number corresponding to each of the equipment models, and an expected WIP number corresponding to each of the equipment models, wherein the type of orders include CTOs and BTOs. The employee work data include all equipment models processable (maintainable and repairable) by each of the employees and UPPH for each of the equipment models.

TABLE 1
(Employee attendance data)

| | Current consecutive |
|---|---|
| Employee i | working days CWDᵢ |
| D0001 | 2 |
| D0002 | 4 |
| D0003 | 1 |
| D0004 | 3 |
| D0005 | 7 |
| D0006 | 10 |
| . . . | . . . |

TABLE 2
(Equipment model data)

| | Equipment | Current WIP | Expected WIP |
|---|---|---|---|
| Order | Model | Number | Number |
| Type k | j | CWQⱼ | IWQⱼ |
| CTO | B001_CTO | 0 | 0 |
| CTO | B002_CTO | 4 | 8 |
| . . . | . . . | . . . | . . . |
| BTO | M001_BTO | 0 | 0 |
| BTO | M002_BTO | 2 | 4 |
| . . . | . . . | . . . | . . . |

TABLE 3
(Employee work data)

| | Equipment | Units Per Person |
|---|---|---|
| Employee i | model j | Per Hour UPPHᵢⱼ |
| D0001 | M001_BTO | 1.74 |
| D0001 | M002_BTO | 1.74 |
| D0001 | M003_BTO | 1.74 |
| D0002 | H001_BTO | 1.40 |
| D0003 | H001_BTO | 2.00 |
| D0003 | H002_BTO | 2.00 |
| D0003 | N001_BTO | 2.00 |
| . . . | . . . | . . . |

In Table 3, the column of “Equipment Model” indicates the equipment models processable (maintainable and repairable) by the employee, and the column of UPPHᵢⱼ indicates the units per person per hour (UPPH) of the employee maintaining and repairing the corresponding equipment model.

The set data include the objective WIP number corresponding to the type of order, the upper limit of regular work shift hours, the bottom limit of regular work shift hours, the upper limit of overtime hours, the bottom limit of overtime hours, and the upper limit of consecutive working days. The set data are parameters set by the users.

After the employee attendance data, the equipment model data, the employee work data, and the set data are input into the optimization model 123, the human resource scheduling plan may then be obtained.

Table 4 provides the employee work shift plan and serves to demonstrate whether the employees are in attendance, whether the employees work overtime, the work shift hours, and the overtime hours. Here, if xᵢ is 1, it indicates that the corresponding employee works in a regular work shift; if yᵢ is 1, it indicates that the corresponding employee works overtime. For instance, xᵢ of the employee D0001 is 1, which indicates that the employee D0001 works in a regular work shift, the regular work shift hours are 8 hours, and the employee D0001 does not work overtime because yᵢ is 0; xᵢ of the employee D0006 is 1, which indicates that the employee D0006 works in a regular work shift, the regular work shift hours are 8 hours, the employee D0006 works overtime because yᵢ is 1, and the overtime hours are 3 hours.

TABLE 4

| | | Regular Work | | |
|---|---|---|---|---|
| Employee | Attendance Status | Shift Hours | Overtime Status | Overtime Hours |
| i | xᵢ | EWHᵢ | yᵢ | EOHᵢ |
| D0001 | 1 | 8 | 0 | 0 |
| D0002 | 1 | 8 | 0 | 0 |
| D0003 | 1 | 8 | 0 | 0 |
| D0004 | 1 | 8 | 0 | 0 |
| D0005 | 1 | 8 | 1 | 4 |
| D0006 | 1 | 8 | 1 | 3 |
| . . . | . . . | . . . | . . . | . . . |

Table 5 provides the employee task assignment plan and demonstrates the equipment models which are required to be processed (maintained and repaired) during the work shift of the corresponding employee, the processing time, and the processed number of the equipment models. For instance, the employee D0001 is capable of maintain and repair three equipment models: M001_BTO, M002_BTO, and M003_BTO. The processing time of the first equipment model M001_BTO is 7.47, while the processing time of the other two equipment models is 0, which indicates that the employee D0001 is merely responsible for maintaining and repairing the equipment model M001_BTO during this work shift, and the processed number of the equipment model is 13.

TABLE 5

| | | | Units | Processed |
|---|---|---|---|---|
| | | | Per | Number of |
| | Equipment | Processing | Person Per | Equipment |
| Employee | Model | Time | Hour | Model |
| i | j | RPT | UPPHᵢⱼ | RPQᵢⱼ |
| D0001 | M001_BTO | 7.47 | 1.74 | 13 |
| D0001 | M002_BTO | 0.00 | 1.74 | 0 |
| D0001 | M003_BTO | 0.00 | 1.74 | 0 |
| D0002 | H001_BTO | 7.86 | 1.40 | 11 |
| D0003 | H001_BTO | 0.00 | 2.00 | 0 |
| D0003 | H002_BTO | 0.00 | 2.00 | 0 |
| D0003 | N001_BTO | 8.00 | 2.00 | 16 |
| . . . | . . . | . . . | . . . | . . . |

Table 6 provides the remaining WIP number table and demonstrates the remaining WIP number of each equipment model (which indicates the remaining WIP number of each equipment model after this shift). For instance, after the work shift ends, the remaining WIP number of the equipment model M001_BTO (corresponding to the type of order BTO) is 219. As to the type of order CTO, in response to the requirements for completing the maintenance and repair before the current work shift ends, the equipment models corresponding to the type of order CTO do not appear in the remaining WIP number table.

TABLE 6

| Equipment Model | Remaining WIP |
|---|---|
| j | Number |
| M001_BTO | 219 |
| M002_BTO | 0 |
| M003_BTO | 43 |
| H001_BTO | 32 |
| H001_BTO | 6 |
| H002_BTO | 0 |
| N001_BTO | 0 |
| . . . | . . . |

To increase readability, the employee work shift plan, the employee task assignment plan, and the remaining WIP number table may be further integrated, so as to obtain an employee task plan (referring to Table 7), an employee work pivot table (referring to Table 8), and an employee work shift hours table (referring to Table 9).

Table 7 provides the employee task plan and demonstrates the equipment model that requires maintenance and repair by the corresponding employee during the work shift. Table 7 records all the equipment models maintained and repaired by each employee corresponding to the type of order, the processing time of each equipment model, the UPPH, and the processed number of each equipment model. After excluding the data of the processing time being 0, the remaining data are the equipment models which should be maintained and repaired by the employees, the processing time, the UPPH, and the processed number of the equipment models. For instance, after excluding the data of the processing time being 0, it is clearly shown that the employee D0001 is merely responsible for the maintenance and repair of one equipment model, and the employee D0006 is responsible for the maintenance and repair of two equipment models.

TABLE 7

| | | | | Processed |
|---|---|---|---|---|
| | | | Units Per | Number of |
| | Equipment | Processing | Person Per | Equipment |
| Employee | Model | Time | Hour | Model |
| i | j | RPT | UPPHᵢⱼ | RPQᵢⱼ |
| D0001 | M001_BTO | 7.47 | 1.74 | 13 |
| D0002 | H001_BTO | 7.86 | 1.40 | 11 |
| D0003 | N001_BTO | 8.00 | 2.00 | 16 |
| D0004 | M002_BTO | 7.69 | 2.34 | 18 |
| D0005 | H0002_BTO | 7.83 | 1.66 | 13 |
| D0006 | S0001_BTO | 0.66 | 4.52 | 3 |
| D0006 | M0003_BTO | 0.66 | 4.52 | 3 |
| . . . | . . . | . . . | . . . | . . . |

Table 8 is the employee work pivot table, which records all equipment models correspondingly maintained and repaired by each employee, the total processing time, and the total processed number of the equipment models. The work pivot table clearly shows the equipment models that are required to be maintained and repaired by each employee, the total processing time, and the total processed number of the equipment models. For instance, the employee D0006 is required to maintain and repair 6 equipment models during the work shift. The total processing time of the 6 equipment models is 11.95, and the total processed number is 54.

TABLE 8

| | | | | Processed |
|---|---|---|---|---|
| | | | | Number of |
| | Equipment | Order | Processing | Equipment |
| Employee | Model | Type | Time | Model |
| D0001 | M001_CTO | CTO | 11.90 | 60 |
| D0001 sub-total | | | 11.90 | 60 |
| D0006 | A0001_CTO | CTO | 0.66 | 3 |
| | M0001_CTO | CTO | 7.86 | 36 |
| | M0002_CTO | CTO | 0.66 | 3 |
| | M0003_CTO | CTO | 1.33 | 6 |
| | S0001_BTO | BTO | 0.66 | 3 |
| | S0001_CTO | CTO | 0.66 | 3 |
| D0006 sub-total | | | 11.95 | 54 |
| . . . | . . . | . . . | . . . | . . . |

Table 9 is the employee work shift hours table, which records the regular work shift hours and the overtime hours of each employee in attendance. The employee work shift hours table excludes the data of the regular work shift hours being 0, and the remaining data are the employees who are arranged to have the regular work shifts and the overtime hours of the employees. For instance, if the overtime hours of the employee D0001 is 0, it indicates that the employee D0001 do not work overtime; if the overtime hours of the employee D0007 is 5.5, it means that in addition to the regular work shift hours (8 hours), the employee D0007 is required to work overtime for 5.5 hours.

TABLE 9

| | Regular Work | Overtime |
|---|---|---|
| | Shift Hours | Hours |
| Employee i | EWHᵢ | EOHᵢ |
| D0001 | 8 | 0 |
| D0002 | 8 | 0 |
| D0003 | 8 | 0 |
| D0004 | 8 | 0 |
| D0005 | 8 | 0 |
| D0006 | 8 | 0 |
| D0007 | 8 | 5.5 |
| . . . | . . . | . . . |

According to one or more embodiments of the disclosure, the user may strategically combine different needs in different decision-making scenarios to evaluate various optimal solutions. The content of the solution covers the regular work shift hours, the overtime hours, the type of equipment model maintained and repaired by the employees, and the processed number assigned to the employees. In addition, a parameter self-adaptive adjustment mechanism is also introduced according to one or more embodiments of the disclosure to determine whether the settings of the current overtime hours and an upper limit of consecutive working days of the employees may meet the needs of maintenance and repair of the equipment models, and relevant suggestions are fed back to the user to facilitate timely adjustment of the human resource scheduling plan. For instance, when the user imports the request for maintaining and repairing the equipment models into the electronic apparatus 100, the electronic apparatus 100 applies the test model 121 to calculate and feed back the suggestion on whether the upper limit of overtime hours and the upper limit of consecutive working days are required to be adjusted and the suggested adjustment values, which may assist the user in re-importing the updated set data into the electronic apparatus 100 after checking and modifying the relevant data in time, so that the optimization model 123 may be applied to find the final and optimal solution to the human resource scheduling plan.

To sum up, according to one or more embodiments of the disclosure, in response to the requirements for maintaining and repairing the equipment models or changes to the related specified work shift conditions, the solution may be found after the adjustment of the plans is timely made, so as to improve operational efficiency and service quality. The experimental results have confirmed that the optimal solution to the combination of highly complex work shift scheduling planning and the maintenance and repair planning may be found within 30 seconds on average, and 99.6% of the time spent on the human resource scheduling plan may be saved (the human resource scheduling plan made manually takes about 2 hours, while the human resource scheduling plan made according to one or more embodiments of the disclosure takes about 30 seconds on average). Thereby, the management of the overtime hours may be optimized, and the overtime costs may be reduced. Besides, the work shifts may be arranged according to the technical levels of the employees, thus improving quality and efficiency and reducing the cost of secondary repairs. In addition, no labor planning work shift is required, which can save labor costs.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A human resource scheduling method, executed by a processor, comprising:
constructing a test model based on a test objective function and a plurality of test constraint formulas;
substituting set data into the test model, and making the test constraint formulas to find a solution based on the test objective function for determining whether the set data are valid based on the solution;
in response to the test model determining that the set data are valid, inputting the set data into an optimization model; and
obtaining a human resource scheduling plan via the optimization model having the set data.

2. The human resource scheduling method according to claim 1, wherein the test objective function aims at minimizing a first tolerance factor of an upper limit of overtime hours and a second tolerance factor of an upper limit of consecutive working days,
after determining whether the set data are valid based on the solution, the method further comprising:
in response to the test model determining that the set data are invalid, feeding back output data corresponding to the solution through the test objective function.

3. The human resource scheduling method according to claim 2, wherein the output data comprises the first tolerance factor or the second tolerance factor, and
the step of determining whether the set data are valid via applying the test objective function comprises:
determining whether the first tolerance factor or the second tolerance factor being equal to 0;
in response to the first tolerance factor and the second tolerance factor being equal to 0, determining that the set data being valid; and
in response to the first tolerance factor or the second tolerance factor being not equal to 0, determining that the set data being invalid.

4. The human resource scheduling method according to claim 1, wherein the human resource scheduling plan comprises:
an employee work shift plan, recording work shift information of a plurality of employees, the work shift information of each of the employees comprising an attendance status, regular work shift hours, an overtime status, and overtime hours, the attendance status representing whether the employees are arranged for presenting at a workplace, the overtime status representing whether the employees arranged to work overtime;
an employee task assignment plan, recording equipment model processing information of the employees, the equipment model processing information of each of the employees comprising: at least one equipment model, processing time of each of the at least one equipment model, units per person per hour (UPPH), and a processed number of each of the at least one equipment model, wherein the UPPH is a labor capacity per unit time; and
a remaining work-in-process number table, recording a remaining work-in-process number of each of the at least one equipment model after the work shifts end.

5. The human resource scheduling method according to claim 4, after obtaining the human resource scheduling plan, the method further comprising:
integrating the employee work shift plan, the employee task assignment plan, and the remaining work-in-process number table for obtaining:
an employee task plan, recording all of the at least one equipment model corresponding to a type of order and processed by each of the employees, the processing time of each of the at least one equipment model, the units per person per hour, and the processed number of each of the at least one equipment model;
an employee work pivot table, recording all of the at least one equipment model correspondingly processed by each of the employees, total processing time, and a total processed number of the at least one equipment model; and
an employee work shift hours table, recording the regular work shift hours and the overtime hours of each of the employees in attendance.

6. The human resource scheduling method according to claim 1, wherein the set data comprise an objective work-in-process number corresponding to a type of order type, an upper limit of regular work shift hours, a bottom limit of the regular work shift hours, an upper limit of overtime hours, a bottom limit of the overtime hours, and an upper limit of consecutive working days;
the test constraint formulas are applied to determine reasonableness of the set data based on the set data, employee attendance data, equipment model data, and employee work data, wherein
the employee attendance data comprises the consecutive working days respectively corresponding to the employees;
the equipment model data comprises a plurality of equipment models corresponding to a plurality of types of order, a current work-in-process number corresponding to each of the equipment models, and an expected work-in-process number corresponding to each of the equipment models;
the employee work data comprises the equipment models which each of the employees is capable of handling and units per person per hour (UPPH) for each of the equipment models, wherein the UPPH is a labor capacity per unit time.

7. The human resource scheduling method according to claim 1, wherein the optimization model comprises a plurality of optimized objective functions and a plurality of objective constraint formulas, the objective constraint formulas are applied to determine the human resource scheduling plan, and after the set data are inputted into the optimization model, the method further comprises:
executing one by one the optimized objective functions based on a function precedence order.

8. The human resource scheduling method according to claim 7, wherein the optimized objective functions comprise a function of minimizing total overtime hours, a function of maximizing a total processed number of the at least one equipment model, and a function of minimizing a total number of the employees in attendance.

9. An electronic apparatus, comprising:
a storage device, for storing a test model and an optimization model; and
a processor, coupled to the storage device, wherein the processor:
constructs the test model based on a test objective function and a plurality of test constraint formulas;
substitutes set data into the test model, and makes the test constraint formulas to find a solution based on the test objective function to determine whether the set data are valid based on the solution;
in response to the test model determining that the set data are valid, inputs the set data into the optimization model; and
obtains a human resource scheduling plan via the optimization model having the set data.

10. The electronic apparatus according to claim 9, wherein the test objective function aims at minimizing a first tolerance factor of an upper limit of overtime hours and a second tolerance factor of an upper limit of consecutive working days,
after determining whether the set data are valid based on the solution, the processor feeds back output data corresponding to the solution through the test objective function in response to the test model determining that the set data are invalid.

11. The electronic apparatus according to claim 10, wherein the output data comprises the first tolerance factor or the second tolerance factor, and the processor:
determines whether the first tolerance factor or the second tolerance factor is equal to 0 via applying the test objective function, wherein
in response to the first tolerance factor and the second tolerance factor are equal to 0, the set data is determined as valid, and
in response to the first tolerance factor or the second tolerance factor is not equal to 0, the set data is determined as invalid.

12. The electronic apparatus according to claim 9, wherein the human resource scheduling plan comprises:
an employee work shift plan, recording work shift information of a plurality of employees, the work shift information of each of the employees comprising an attendance status, regular work shift hours, an overtime status, and overtime hours, the attendance status representing whether the employees being arranged to be for presenting at a workplace, the overtime status representing whether the employees being arranged to work overtime;
an employee task assignment plan, recording equipment model processing information of the employees, the equipment model processing information of each of the employees comprising: at least one equipment model, processing time of each of the at least one equipment model, units per person per hour (UPPH), and a processed number of each of the at least one equipment model, wherein the UPPH is a labor capacity per unit time; and
a remaining work-in-process number table, recording a remaining work-in-process number of each of the at least one equipment model after the work shifts end.

13. The electronic apparatus according to claim 12, wherein the processor:
integrates the employee work shift plan, the employee task assignment plan, and the remaining work-in-process number table after obtaining the human resource scheduling plan and obtains:
an employee task plan, recording all of the at least one equipment model corresponding to a type of order and processed by each of the employees, the processing time of each of the at least one equipment model, the units per person per hour, and the number of each of the at least one equipment model;
an employee work pivot table, recording all of the at least one equipment model correspondingly processed by each of the employees, total processing time, and a total processed number of the at least one equipment model; and
an employee work shift hours table, recording the regular work shift hours and the overtime hours of each of the employees in attendance.

14. The electronic apparatus according to claim 9, wherein the set data comprise an objective work-in-process number corresponding to a type of order, an upper limit of regular work shift hours, a bottom limit of regular work shift hours, an upper limit of overtime hours, a bottom limit of overtime hours, and an upper limit of consecutive working days;
the test constraint formulas are applied to determine reasonableness of the set data based on the set data, employee attendance data, equipment model data, and employee work data, wherein
the employee attendance data comprise the consecutive working days respectively corresponding to the employees;
the equipment model data comprise a plurality of equipment models corresponding to a plurality of types of order, a current work-in-process number corresponding to each of the equipment models, and an expected work-in-process number corresponding to each of the equipment models;
the employee work data comprise the equipment models which each of the employees is capable of handling and units per person per hour (UPPH) for each of the equipment models, wherein the UPPH is a labor capacity per unit time.

15. The electronic apparatus according to claim 9, wherein the optimization model comprises a plurality of optimized objective functions and a plurality of objective constraint formulas, the objective constraint formulas are applied to determine the human resource scheduling plan, and
after inputting the set data into the optimization model, the processor executes one by one of the optimized objective functions based on a function precedence order.

16. The electronic apparatus according to claim 15, wherein the optimized objective functions comprise a function of minimizing total overtime hours, a function of maximizing a total processed number of the at least one equipment model, and a function of minimizing a total number of the employees in attendance.

17. A human resource scheduling method, executed by a processor, comprising:
constructing an optimization model based on a plurality of optimized objective functions and a plurality of objective constraint formulas, wherein the optimized objective functions comprise a function of minimizing total overtime hours, a function of maximizing a total processed number of equipment models, and a function of minimizing a total number of employees in attendance; and
inputting set data into the optimization model and executing one by one the optimized objective functions based on a function precedence order to obtain a human resource scheduling plan corresponding to the optimized objective functions.

18. The human resource scheduling method according to claim 17, wherein before inputting the set data into the optimization model, the method further comprises:
constructing a test model based on the optimization model; and
determining whether the set data are valid via applying the test model, wherein in response to the test model determining that the set data is valid, inputting the set data into the optimization model.

19. The human resource scheduling method according to claim 17, wherein the human resource scheduling plan comprises:
an employee work shift plan, recording work shift information of a plurality of employees, the work shift information of each of the employees comprising an attendance status, regular work shift hours, an overtime status, and overtime hours, the attendance status representing whether the employees is arranged to be for presenting at a workplace, the overtime status representing whether the employees are arranged to work overtime;
an employee task assignment plan, recording equipment model processing information of the employees, the equipment model processing information of each of the employees comprising: at least one equipment model, processing time of each of the at least one equipment model, units per person per hour (UPPH), and a processed number of each of the at least one equipment model, wherein the UPPH is a labor capacity per unit time; and
a remaining work-in-process number table, recording a remaining work-in-process number of each of the at least one equipment model after the work shifts end, wherein after obtaining the human resource scheduling plan, the method further comprising:
integrating the employee work shift plan, the employee task assignment plan, and the remaining work-in-process number table for obtaining:
an employee task plan, recording all of the at least one equipment model corresponding to a type of order and processed by each of the employees, the processing time of each of the at least one equipment model, the units per person per hour, and a processed number of each of the at least one equipment model;
an employee work pivot table, recording all of the at least one equipment model correspondingly processed by each of the employees, total processing time, and a total processed number of the at least one equipment model; and
an employee work shift hours table, recording the regular work shift hours and the overtime hours of each of the employees in attendance.

20. The human resource scheduling method according to claim 18, wherein the set data comprise an objective work-in-process number corresponding to a type of order, an upper limit of regular work shift hours, a bottom limit of regular work shift hours, an upper limit of overtime hours, a bottom limit of overtime hours, and an upper limit of consecutive working days;
the test model comprise a plurality of test constraint formulas, wherein the test constraint formulas are applied to determine reasonableness of the set data based on the set data, employee attendance data, equipment model data, and employee work data, wherein
the employee attendance data comprise the consecutive working days respectively corresponding to the employees;
the equipment model data comprise a plurality of equipment models corresponding to a plurality of types of order, a current work-in-process number corresponding to each of the equipment models, and an expected work-in-process number corresponding to each of the equipment models;
the employee work data comprises the equipment models which each of the employees is capable of handling and units per person per hour (UPPH) for each of the equipment models, wherein the UPPH is a labor capacity per unit time.
